(19) United States
(12) Patent Application Publication
(10) Pub. No.: US 2025/0236393 A1
(43) Pub. Date: Jul. 24, 2025

(54) DOUBLE-DECKER SEMI-RECLINING AIRPLANE SEAT

(71) Applicant: Gaowei Xu, Vaughan (CA)

(72) Inventor: Gaowei Xu, Vaughan (CA)

(21) Appl. No.: 19/176,250

(22) Filed: Apr. 11, 2025

(30) Foreign Application Priority Data
Apr. 16, 2024 (CN) 2024104543373

(51) Int. Cl. B64D 11/06; B64D 25/04

(52) U.S. Cl. CPC B64D 11/0601; B64D 11/064; B64D 25/04; B64D 11/0638

(57) ABSTRACT

This invention pertains to aircraft seating, specifically a double-decker semi-reclining airplane seat designed to enhance passenger comfort in economy class. It comprises a front support frame, a rear support frame, a lower seat, and an upper seat. The support frames are positioned parallel and obliquely on a slide rail. The lower seat, situated between the frames, features a movable seatback and a hinged seat base. The upper seat includes a hinged seatback, seat base, and leg support, with a footrest platform hinged to the front support frame. This design optimizes limited cabin space while providing a more ergonomic seating arrangement. Evenly distributing body weight reduces pressure on the waist, hips, and legs, alleviating discomfort from prolonged sitting. Compared to traditional economy seats, this innovation offers improved reclining support, enhancing overall passenger comfort during long flights.

### FIELD OF INVENTION

The invention relates to the technical field of aircraft equipment, in particular with a double-decker semi-reclining airplane seat which can be installed and used in aircraft cabin.

### BACKGROUND

Traveling by plane is the first choice for many people for medium and long-distance travel because of its advantages of being fast, convenient, safe and reliable. For most people, choosing to travel in economy class is a convenient and low-cost way to travel. However, the passengers taking an economy class seat to complete a long-distance flight will inevitably feel back pain and swollen legs and feet due to long-time sitting. This is because passengers have to sit for a long time, their movements are limited, and the weight of their upper body is on their waist and hips. Based on the principles of ergonomics, although the current economy class seat design has appropriately improved the comfort through increasing the backrest inclination, it still does not change the sitting posture. However, full flat or reclining seats are not suitable for economy class because it is difficult to ensure a high-density seat layout while having the fundamental activity space. Seat number reduction affects the revenue of airlines.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to the double-decker semi-reclining airplane seat that enhances passenger comfort. The seat consists of a front support frame and a rear support frame, a lower seat, and an upper seat, all arranged obliquely on a slide rail. The lower seat has a movable seatback and a hinged seat base, while the upper seat includes a hinged seatback, seat base, and leg support, with a footrest platform attached to the front support frame.

The lower seat base is positioned at an incline and features a curling surface that slides along the rail via its supporting leg. The upper seat base moves within a short slide groove at the top of the rear frame. Side ladders, which double as armrests when stowed, facilitate access to the upper seat. These ladders slide and lock into different positions using a clamping mechanism.

For added convenience, a passenger service unit is integrated into the upper seat for lower-deck passengers. A ventilation pipe connects to the aircraft's air system, distributing air through ducts within the upper seatback. Life jackets are stored in the upper leg support and lower seat base, while emergency oxygen supplies are equipped under the upper seat base. The front frame accommodates an entertainment system and foldable cup holders.

The double-decker semi-reclining airplane seat maximizes aircraft cabin space without significantly reducing seating capacity. The semi-reclining structure provides better weight distribution, reducing pressure on the waist, hips, and legs, thereby alleviating discomfort from prolonged sitting. Adjustable seat angles and sliding components accommodate different body sizes, offering a more ergonomic alternative to traditional airplane seating.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

In the following detailed portion of the present description, the teachings of the present application will be explained in more detail with reference to the example embodiments shown in the drawings, in which:

FIG. 1 is a schematic diagram of the exploded structure of the double-decker semi-reclining airplane seat provided by the present invention;

FIG. 2 is a schematic diagram of the assembly structure of the double-decker semi-reclining airplane seat provided by the present invention.

Figure numerals: 1, slide rail; 2, front support frame; 3, rear support frame; 4, lower seat; 41, lower seatback; 42, lower seat base; 43, baffle; 5, upper seat; 51, upper seatback; 52, upper seat base; 53, upper leg support; 54, footrest platform; 55, side ladder; 6, passenger service unit; 7, seat cushion; 8, storage layer; 9, storage box.

Obviously, the drawings described above are some embodiments of the present invention. For ordinary technicians in this field, other drawings can also be obtained based on these drawings without creative work.

### DETAILED DESCRIPTION

In order to make the purpose, technical solution and advantages of the present invention clearer, the technical solution of the present invention will be described clearly and completely in conjunction with the drawings in the present invention. Obviously, the described embodiments are part of the embodiments of the present invention, not all of the embodiments. Based on the embodiments in the present invention, all other embodiments obtained by ordinary technicians in the field without creative work belong to the scope of protection of the present invention.

In the description of the embodiments of the present invention, it should be noted that the orientation or position relationship indicated by the terms “center”, “longitudinal”, “lateral”, “upper”, “lower”, “front”, “back”, “left”, “right”, “vertical”, “horizontal”, “top”, “bottom”, “inside”, “outside” and the like are based on the orientation or position relationship shown in the drawings, which is only for the convenience of describing the embodiments of the present invention and simplifying the description, rather than indicating or implying that the device or element referred to must have a specific orientation, be constructed and operated in a specific orientation, and therefore cannot be understood as a limitation on the embodiments of the present invention.

In the description of the embodiments of the present invention, it should be noted that, unless otherwise clearly specified and limited, the terms “connected” and “connected” should be understood in a broad sense, for example, it can be a fixed connection, a detachable connection, or an integral connection. It can be directly connected or indirectly connected through an intermediate medium. For ordinary technicians in this field, the specific meanings of the above terms in the embodiments of the present invention can be understood in specific circumstances.

In the embodiments of the present invention, unless otherwise clearly specified and limited, the first feature “above” or “below” the second feature may be that the first and second features are in direct contact, or the first and second features are in indirect contact through an intermediate medium. Moreover, the first feature “above” the second feature may be that the first feature is directly above or obliquely above the second feature, or simply indicates that the first feature is higher in level than the second feature. The first feature “below” the second feature may be that the first feature is directly below or obliquely below the second feature, or simply indicates that the first feature is lower in level than the second feature.

In the description of this specification, the description of reference terms such as “one embodiment”, “some embodiments”, “examples”, “specific examples”, or “some examples” means that the specific features, structures, materials or characteristics described in conjunction with the embodiment or example are included in at least one embodiment or example of the embodiments of the present invention. In this specification, the schematic representation of the above terms does not necessarily refer to the same embodiment or example. Moreover, the specific features, structures, materials or characteristics described may be combined in an appropriate manner in any one or more embodiments or examples. In addition, without contradiction, those skilled in the art may combine and combine the different embodiments or examples and the features of the different embodiments or examples described in this specification.

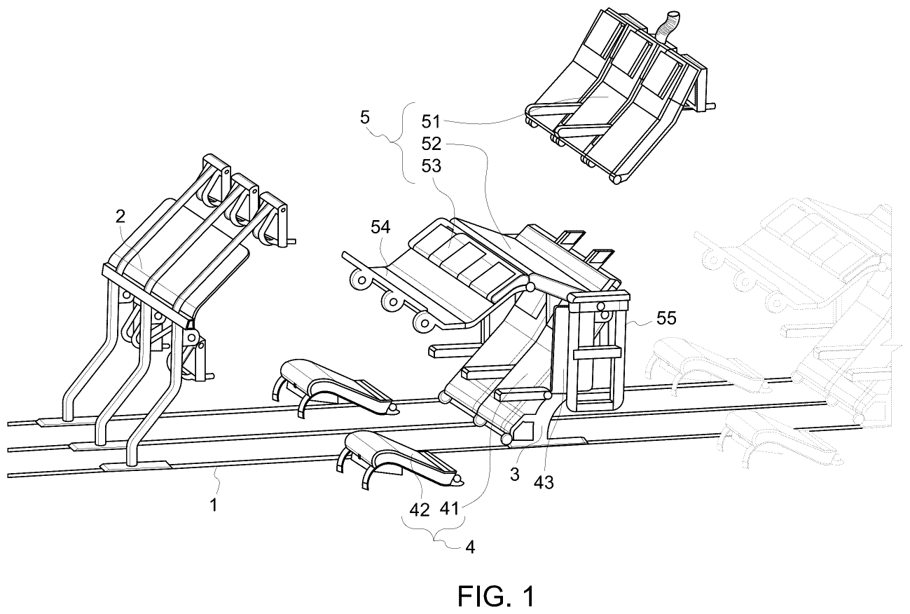

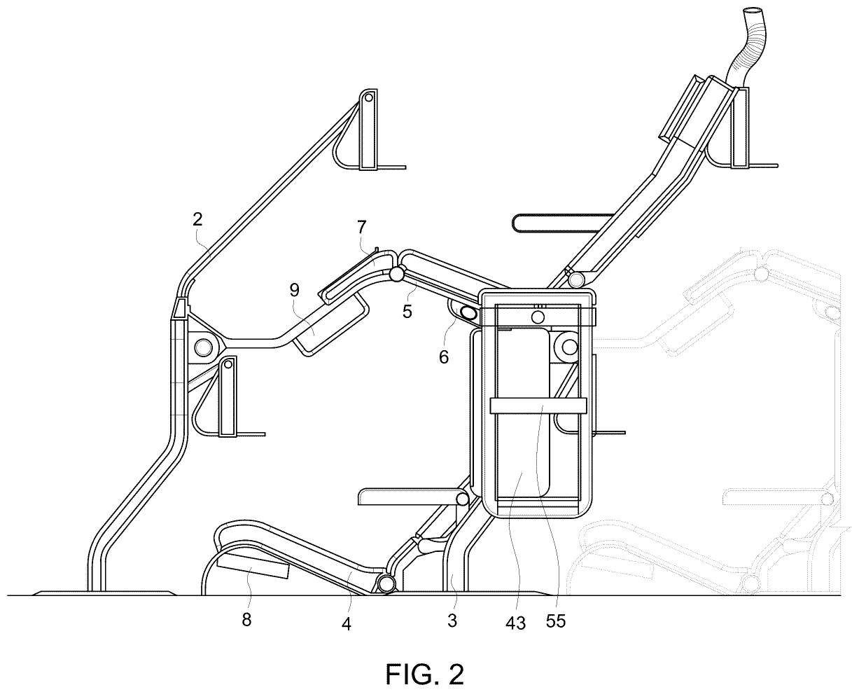

The specific structure of the double-decker semi-reclining airplane seat of the present invention is described below in conjunction with FIG. 1 and FIG. 2.

In one embodiment of the present invention, a double-decker semi-reclining airplane seat is provided, as shown in FIG. 1 and FIG. 2 includes a slide rail 1, a front support frame 2, a rear support frame 3, a lower seat 4, and an upper seat 5. The front support frame 2 and the rear support frame 3 are arranged in parallel and are both arranged obliquely on the slide rail 1. The lower seat 4 is located between the front support frame 2 and the rear support frame 3, and the lower seat includes a lower seatback 41 and a lower seat base 42, and the lower seatback 41 is movably connected to the rear support frame 3. The support frame 3 faces the side of the front support frame 2, and the lower seat base 42 is hinged to the lower seatback 41. The upper seat 5 includes an upper seatback 51, an upper seat base 52 and an upper leg support 53, the upper seatback 51 and the upper seat base 52 are hinged, the upper seat base 52 is movably connected to the upper end of the rear support frame 3, the upper leg support 53 and the upper seat base 52 are hinged, and a footrest platform 54 is arranged at the lower end of the upper leg support 53, and the footrest platform 54 is hinged to the front support frame 2.

The double-decker semi-reclining airplane seat of this embodiment is a compromise between traditional seats and flat-lying seats. The most ideal arrangement is the seat area located in the middle of the two aisles of a wide-body aircraft, while the seat areas on both sides are still arranged with traditional seats. Such an arrangement can effectively utilize the space in the cabin and will hardly affect the passenger capacity of the economy class.

Specifically, the front support frame 2 has two forms. The front support frame 2 located at the front end of the seat area is a separately arranged support frame. Starting from the second row of seats, the front support frame 2 can be the backrest and rear support frame of the front row of seats. The lower seat 4 is composed of a lower seatback 41 and a lower seat base 42, and the upper seat 5 is composed of an upper seatback 51, an upper seat base 52, and an upper leg support 53. The lower seatback 41 and the upper seatback 51 can both be adjusted to a small degree of inclination angle through a hinge structure, which is suitable for self-adjustment according to passenger needs. The lower seat 4 and the upper seat 5 of this embodiment, as well as the front support frame 2 and the rear support frame 3 are all arranged on the slide rail 1. Since the parts of the lower seat 4 and the upper seat 5 are hinged, they can be adjusted forward and backward within a certain small range, which is suitable for meeting the body length requirements of passengers.

Although, the double-decker semi-reclining airplane seat of this embodiment occupies more space than traditional seats in terms of the front-to-back length of a single seat, due to the double-decker structure, the same space can provide a seat volume similar to that of a traditional aircraft cabin, making full use of the limited space of the economy class, and providing a more comfortable semi-reclining seat than a traditional seat. The semi-reclining seat can distribute the weight of the body relatively evenly to the whole body, thereby reducing the pressure of the body on the waist, hips, and legs, so as to relieve various discomforts caused by long-term sitting and increase the comfort of passengers.

Specifically, in some embodiments, the double-decker semi-reclining airplane seat of the present invention, the hinged part of the lower seat base 42 and the lower seatback 41 is slidably arranged on the slide rail 1, the end of the lower seat base 42 close to the front support frame 2 is higher than the end away from the front support frame 2, and the end of the lower seat base 42 close to the front support frame 2 is provided with a downward curling surface, and the bottom of the curling surface is slidably connected to the slide rail 1 through the support leg.

Compared with traditional cabin seats, the lower seat 4 of this embodiment has no substantial chair legs. After entering the lower seat 4, the passenger is in a semi-reclining sitting state. The lower seat base 42 is hinged with the lower seatback 41, and the inclination angle of the lower seatback 41 can be adjusted. When passengers sit on the lower seat base 42, their legs can be comfortably relaxed on the curled surface in front of the lower seat base 42. By adjusting the front and rear positions of the lower seat base 42 on the slide rail 1, a more comfortable space can be obtained.

Similarly, in other embodiments, the upper seat 5 of the double-decker semi-reclining airplane seat of the present invention is similar to the lower seat 4 and can also be adjusted. Specifically, a short slide groove parallel to the slide rail 1 is provided at the upper end of the rear support frame 3, and the upper seat base 52 is slidably arranged in the slide groove. The upper seat 5 is adjusted by fine-tuning the front and rear position of the upper seat base 52 in the slide groove.

In some embodiments, in the structure of the double-decker semi-reclining airplane seat of the present invention, side ladders 55 are movably arranged on both sides of the upper seat 5, and the side ladders 55 are suitable for switching between a first position and a second position. In the first position, the side ladder 55 is located at the upper side of the upper seat 5, serving as an armrest of the upper seat 5. In the second position, the side ladder 55 is located at the lower side of the upper seat 5, serving as a ladder for the upper-deck passengers.

The side ladder 55 is set up to facilitate the upper-deck passengers to get on and off. The side ladder 55 has two functions. One is to act as a passenger ladder when it is in the second position. When a passenger is sitting in the upper seat 5, they can pull up the side ladder 55 to set it at the first position. The second function of the side ladder 55 is to act as an armrest for the upper-deck passengers. It can also prevent passengers from falling from the upper seat 5 when a flight is experiencing turbulence. The side ladder 55 can also indicate passenger actions. If the side ladder 55 is lowered to the second position, then the lower-deck passengers can realize that their upper-deck passengers need to leave their seats, which can avoid conflicts if they both want to leave their seats at the same time.

The structural setting of the side ladder 55 is described below in conjunction with specific examples:

In a specific example, a rotating shaft is set on the side of the upper seat base 52, and the side ladder 55 is hinged on the rotating shaft. A buckle is set on the top of the side ladder 55, and a buckle position is set on the side of the upper seatback 51 and the upper seat base 52. In this example, the side ladder 55 can rotate around the axis of the rotation shaft. When the side ladder 55 is set vertically, the side ladder 55 is in the second position and serves as a passenger ladder. When the side ladder 55 rotates up to the first position, the side ladder 55 is parallel to the upper seat base 52 and serves as a handrail and safety guardrail.

In another specific example, a vertical sliding groove is provided on the side of the upper seat base 52, and the side ladder 55 is slidably provided in the sliding groove. A first clamping position and a second clamping position are provided in the sliding groove, and a buckle is provided on the side of the side ladder 55 facing the sliding groove, when the buckle is in the first clamping position, the side ladder 55 is in the first position, and when the buckle is in the second clamping position, the side ladder 55 is in the second position. In this example, the side ladder 55 can slide up and down along the sliding groove, positioned by buckling with the first clamping position or the second clamping position. When the buckle is in the first clamping position, the side ladder 55 is in the first position and is above the upper seat base 52, which can serve as an armrest for the upper-deck passengers. When the buckle is in the second clamping position, the side ladder 55 is in the second position and is below the upper seat base 52, which allows passengers to get on and off.

Based on the structures in the above examples, in this embodiment, baffles 43 are fixedly set on both sides of the lower seat 4 facing against the position of the side ladder 55. The baffles 43 not only prevent the upper-deck passengers from bothering the lower-deck passengers when using the side ladder 55 but also increase the privacy of the passengers in the lower deck.

In some application structures of the double-decker semi-reclining airplane seats of the present invention, the seats of the upper and lower decks are not arranged uniformly. The upper deck can be provided with three to four upper seats 5 arranged side by side, and the upper seats 5 on the outermost sides are equipped with side ladders 55, while the lower deck has only two to three lower seats 4 arranged side by side. Such a structure can offer passengers more choices. The advantages of the upper seats 5 on the upper deck are the foot space and head space, while the advantages of the lower seats 4 on the lower deck are the width of the seats.

Based on the structure of the double-decker semi-reclining airplane seats in the above-mentioned embodiments, the following embodiment further improves the structure: A passenger service unit 6 for the lower-deck passengers is provided on the side of the upper seat base 52 facing the lower seat 4. A ventilation duct for connecting to the aircraft air supply system is provided on the top of the upper seatback 51, and an air duct is built inside the upper seatback 51, and the air duct connects the ventilation duct and the air supply port on the passenger service unit 6. In this embodiment, the passenger service unit for the passengers in the upper seat 5 is located at the rack of overhead bins, while the passenger service unit 6 used by the passengers in the lower seat 4 is located on the side of the upper seat base 52 facing the lower seat 4, and the passenger service unit 6 includes an air outlet, a call button, a night light, etc. The ventilation duct and the air duct built into the chair deliver fresh air to the passenger service unit 6 of the lower-deck passengers.

In some examples, a cushion 7 is provided on the upper leg support 53 of the double-decker semi-reclining airplane seat of the present invention, and a life jacket for the upper-deck passengers is embedded in the cushion 7. A storage layer 8 is provided on the bottom side of the lower seat base 42, and the storage layer 8 is used to store life jackets for the lower-deck passengers. A storage box 9 is provided on the bottom side of the upper leg support 53, and the storage box 9 is built with oxygen candles and oxygen masks for the lower-deck passengers to use in an emergency. The oxygen masks used by the upper-deck passengers in an emergency are located on the rack of overhead bins. The above-mentioned example structure is set up to meet the emergency needs of the cabin passengers. In addition, the front support frame 2 is provided with a passenger entertainment system and folding cup holders corresponding to the positions of the lower seat 4 and the upper seat 5.

Finally, it should be noted that the above embodiments are only used to illustrate the technical solutions of the present invention, rather than to limit it. Although the present invention has been described in detail with reference to the aforementioned embodiments, those skilled in the art should understand that they can still modify the technical solutions described in the aforementioned embodiments, or make equivalent replacements for some of the technical features therein. However, these modifications or replacements do not deviate the essence of the corresponding technical solutions from the spirit and scope of the technical solutions of the embodiments of the present invention.

The claimed invention is:

1. A double-decker semi-reclining airplane seat, comprising:
a front support frame and a rear support frame, wherein the front support frame and the rear support frame are arranged in parallel and both are arranged obliquely on a slide rail;
a lower seat, located between the front support frame and the rear support frame, wherein the lower seat comprises a lower seatback and a lower seat base, wherein the lower seatback is movably connected to the rear support frame on the side facing the front support frame, and the lower seat base is hinged to the lower seatback; and
an upper seat comprises an upper seatback, an upper seat base and an upper leg support, wherein the upper seatback and the upper seat base are hinged, wherein the upper seat base is movably connected to the upper end of the rear support frame, and the upper leg support and the upper seat base are hinged.

2. The double-decker semi-reclining airplane seat of claim 1, wherein the connection portion between the lower seat base and the lower seatback is arranged on the base of the rear support frame, wherein the end of the lower seat base close to the front support frame is higher than the end away from the front support frame, and is provided with a downwardly facing curling surface, and the bottom of the curling surface is slidably connected to the slide rail through its supporting leg.

3. The double-decker semi-reclining airplane seat of claim 1, wherein the upper end of the rear support frame is provided with a short slide groove parallel to the slide rail, and the upper seat base is slidably arranged in the slide groove.

4. The double-decker semi-reclining airplane seat any one of claims 1 to 3, wherein the upper seat comprises side ladders that are movably provided on both sides of the upper seat, and wherein the side ladders are suitable for switching between a first position and a second position, wherein the side ladders are located at the upper side of the upper seat and serve as an armrest of the upper seat when positioned in the first position, wherein the side ladders are located at the lower side of the upper seat and serve as a ladder for upper-deck passengers when positioned in the second position.

5. The double-decker semi-reclining airplane seat of claim 4, wherein a rotating shaft is provided on the side of the upper seat base, the side ladders are fixed on the rotating shaft, a buckle is provided on the top of the side ladder, and a buckle is provided on the side of the upper seatback and the upper seat base.

6. The double-decker semi-reclining airplane seat of claim 4, wherein the upper seat base is provided with a vertical sliding groove, and the side ladder is slidably provided in the sliding groove, wherein the sliding groove is provided with a first clamping position and a second clamping position, and a buckle is provided on the side of the side ladder facing the sliding groove, wherein the side ladder is in the first position when the buckle is in the first latching position, and the side ladder is in the second position when the buckle is in the second latching position.

7. The double-decker semi-reclining airplane seat of claim 4, wherein the baffles are equipped on both sides of the lower seat facing against the position of the side ladder.

8. The double-decker semi-reclining airplane seat any one of claims 1 to 3, wherein the upper seat base features, on the side facing the lower seat, a passenger service unit intended for use by passengers on the lower deck, wherein the upper seatback is equipped, on the top, with a ventilation duct designed to connect to the aircraft air supply system, wherein the upper seatback is integrated with an air duct that connects the ventilation duct to the air supply port on the passenger service unit.

9. The double-decker semi-reclining airplane seat any one of claims 1 to 3, wherein the upper leg support is fitted with a seat cushion that comprises a life jacket for upper-deck passengers, wherein the lower seat base is configured with a storage layer on the bottom side for storing life jackets for lower-deck passengers, wherein the upper leg support is equipped with a storage box on its bottom side for storing oxygen candles and masks.

10. The double-decker semi-reclining airplane seat any one of claims 1 to 3, wherein the front support frame is provided with a passenger entertainment system and folding cup holders at positions corresponding to the lower seat and the upper seat.
